(19) United States
(12) Patent Application Publication
(10) Pub. No.: US 2021/0178468 A1
(43) Pub. Date: Jun. 17, 2021

(54) Aluminum Based Metal Powders and Methods of Their Production

(71) Applicant: AP&C Advanced Powders & Coatings Inc., Boisbriand (CA)

(72) Inventors: Frederic Larouche, Saint-Colomban (CA); Matthieu Balmayer, Montreal (CA); Frederic Marion, Montreal (CA)

(21) Appl. No.: 17/032,689

(22) Filed: Sep. 25, 2020

Related U.S. Application Data
(60) Provisional application No. 62/906,960, filed on Sep. 27, 2019.

(51) Int. Cl. B22F 1/00; B22F 9/08

(52) U.S. Cl. CPC B22F 1/0011; B22F 9/082; B22F 2201/03; B22F 2999/00; B22F 2998/00

(57) ABSTRACT

Aluminum-based metallic powders, along with their methods of production and formation, are provided. The Al-based metallic powders are formed with an increased amount of oxygen within at least a portion of the particles of the powder. The Al-based metallic powders show improved flowability.

### PRIORITY INFORMATION

The present application claims priority to U.S. Provisional Patent Application Ser. No. 62/906,960 filed on Sep. 27, 2019, which is incorporated by reference herein for all purposes.

### FIELD

The present disclosure relates to the field of production of spheroidal powders, such as Al-based metal powders. More particularly, it relates to methods for preparing Al-based metal powders having improved flowability.

### BACKGROUND

Fine powders are useful for applications such as 3D printing, powder injection molding, hot isostatic pressing and coatings. Such fine powders are used in aerospace, biomedical and industrial fields of applications. Typically, the desired features of Al-based metal powders will be a combination of high sphericity, density, purity, flowability, and low amount of gas entrapped porosities.

A powder having poor flowability may tend to form agglomerates having lower density and higher surface area. These agglomerates can be detrimental when used in applications that require of fine Al-based metal powders. Furthermore, reactive powder with poor flowability can cause pipes clogging and/or stick on the walls of an atomization chamber of an atomizing apparatus or on the walls of conveying tubes. Moreover, powders in the form of agglomerates are more difficult to sieve when separating powder into different size distributions. Manipulation of powder in the form of agglomerates also increases the safety risks as higher surface area translates into higher reactivity.

By contrast, Al-based metal powders having improved flowability are desirable for various reasons. For example, they can be used more easily in powder metallurgy processes as additive manufacturing and coatings.

### BRIEF DESCRIPTION

Aspects and advantages will be set forth in part in the following description, or may be obvious from the description, or may be learned through practice of the invention.

Metallic powders are generally provided, along with their methods of production and formation. In particular embodiments, the metallic powder comprising a plurality of Al-based metallic particles comprising at least 50% by weight aluminum. The plurality of Al-based metallic particles may include a first portion of Al-based metallic particles.

In one embodiment, each Al-based metallic particle of the first portion of Al-based metallic particles may comprise a maximum oxygen concentration and a half oxygen concentration that is 50% of the maximum oxygen concentration, with the half oxygen concentration being measured at a sputtering time that is 2.8 minutes or greater as measured via auger electron spectroscopy.

In one embodiment, the first portion of Al-based metallic particles may comprise a normalized half oxygen concentration that is 50% of a normalized maximum oxygen concentration, with the normalized half oxygen concentration to particle surface area being 0.002 min/μm² or greater as measured via auger electron spectroscopy.

In one embodiment, each Al-based metallic particle of the first portion of Al-based metallic particles may comprise oxygen distributed in the particle such that each of the portion of the Al-based metallic particles has a charted area under an oxygen concentration curve plotted as measured via auger electron spectroscopy, with the charted area being 7.5% or greater for a sputtering time of 20 minutes.

In one embodiment, each Al-based metallic particle of the first portion of Al-based metallic particles may have an average grain area fraction of 75% or greater.

In one embodiment, each Al-based metallic particle of the first portion of Al-based metallic particles have an average eutectic fraction of 25% or less.

In one embodiment, each Al-based metallic particle of the first portion of Al-based metallic particles may have an average porosity of 0.2% or less.

In one embodiment, the first portion of Al-based metallic particles may have an average grain fraction measurement of 75% or greater.

Methods are also generally provided for forming an Al-based metal powder. In one embodiment, the method may include atomizing a heated Al-based metal source to produce a raw Al-based metal powder; contacting said heated Al-based metal source with an atomization gas and an oxygen-containing gas; and forming, with the oxygen, an oxide within the Al-based metal powder.

In one embodiment, the method may include: supplying an Al-based source metal into a heat zone of an atomizer such that Al-based metallic particles are formed in a plasma field (e.g., where the Al-based metallic source material comprises at least 50% by weight aluminum and has an initial oxygen concentration); and supplying oxygen into the atomizer such that a majority of the Al-based metallic particles have a particle oxygen concentration that is greater than the initial oxygen concentration of the Al-based metallic source material.

In one embodiment, the method may include: forming Al-based metallic particles in a plasma field of a heat zone of an atomizer from an Al-based metallic source material (e.g., where the Al-based metallic source material comprises at least 50% by weight aluminum); and directing oxygen into the atomizer such that oxygen reacts with aluminum on and within the Al-based metallic particles to form aluminum oxides therein. A majority of the Al-based metallic particles may comprise a normalized half oxygen concentration that is 50% of a normalized maximum oxygen concentration, with the normalized half oxygen concentration is 0.002 min/μm² or greater as measured via auger electron spectroscopy.

In one embodiment, an Al-based metal powder atomization manufacturing process is generally provided, such as the methods described above. For example, in one embodiment, the process may include: atomizing a heated Al-based metal source to produce a raw Al-based metal powder; contacting said heated Al-based metal source with an atomization gas and an oxygen-containing gas; and forming, with the oxygen, an oxide within the raw Al-based metal powder such that a majority of the Al-based metallic particles have a particle oxygen concentration that is greater than the initial oxygen concentration of the Al-based metallic source material.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 shows a schematic of one embodiment of an exemplary atomization system;

FIG. 2 shows that the maximum oxygen for an exemplary particle profile according to one embodiment of the Examples;

FIG. 3 shows the average oxygen (area under the oxygen profile, represented with the slashed lines) for an exemplary particle profile according to one embodiment of the Examples;

FIG. 4 shows a table summarizing the particle diameter, sputter time to reach ½ the maximum oxygen concentration and the average oxygen % from 0 to 20 minute, according to the Examples;

FIGS. 5A, 5B, and 5C show particle sizes analyzed varied between the three powders according to the Examples;

FIGS. 6A and 6B show the surface area of each particle calculated and the ½ Max O and % Oxygen normalized to the particle surface area;

FIGS. 7A, 7B, 7C, 7D, 7E show the AES data for the five labeled particles in the SEM images shown in FIGS. 7F and 7G of the exemplary PA powder;

FIGS. 8A, 8B, 8C, 8D, 8E show the AES data for the five labeled particles in the SEM images shown in FIGS. 8F and 8G of the comparative PA powder;

FIGS. 9A, 9B, 9C, 9D, 9E show the AES data for the five labeled particles in the SEM images shown in FIG. 9F of the comparative GA powder;

FIG. 10 shows the area fraction measurements;

FIG. 11 shows the equivalent circle diameter measurements (μm);

FIG. 12 shows the average grain size of these powders;

FIG. 13 shows a histogram of the powders;

FIG. 14A shows a SEM image of an exemplary PA particle;

FIG. 14B shows a processed image of the SEM image of FIG. 14A;

FIG. 15A shows a SEM image of a particle from the comparative PA powder;

FIG. 15B shows a processed image of the SEM image of FIG. 15A;

FIG. 16A shows a SEM image of a particle from the comparative GA powder;

FIG. 16B shows a processed image of the SEM image of FIG. 16A;

FIG. 17 shows the Grain Size Distribution of the three powders; and

FIG. 18A, FIG. 18B, and FIG. 18C show the processing of the Line Analysis Test performed according to the process described in the Examples below.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The expression “atomization zone” as used herein, when referring to a method, apparatus or system for preparing a metal powder, refers to a zone in which the material is atomized into droplets of the material. The person skilled in the art would understand that the dimensions of the atomization zone will vary according to various parameters such as of the atomizing means, velocity of the atomizing means, material in the atomizing means, power of the atomizing means, temperature of the material before entering in the atomization zone, nature of the material, dimensions of the material, electrical resistivity of the material, etc.

The expression “heat zone of an atomizer” as used herein refers to a zone where the powder is sufficiently hot to react with the oxygen atoms of the oxygen-containing gas in order to generate an oxide within the particles, as discussed in embodiments of the present disclosure.

The expression “metal powder has a X-Y μm particle size distribution means it has less than 5% wt. of particle above Y μm size with the latter value measured according to ASTM B214-16 standard. It also means it has less than 6% wt. of particle below X μm size (d6≥X μm) with the latter value measured according to ASTM B822 standard.

The expression “metal powder having a 15-45 μm particle size means it has less than 5% wt. of particle above 45 μm (measured according to ASTM B214-16 standard) and less than 6% wt. of particle below 15 μm (measured according to ASTM B822 standard).

The expression “Gas to Metal ratio” as used herein refers to the ratio of mass per unit of time (kg/s) of gas injected on the mass feed rate (kg/s) of the metal source provided in the atomization zone.

The term “raw Al-based metal powder” as used herein refers to an Al-based metal powder obtained directly from an atomization process without any post processing steps such as sieving or classification techniques.

A metallic powder is generally provided that includes a plurality of Al-based metallic particles, along with methods of their production. The metallic powder is generally prepared via a plasma atomization process. Plasma atomization generally involves atomizing a heated Al-based metal source to produce a raw Al-based metal powder and contacting said heated Al-based metal source with an atomization gas comprising oxygen. Generally, the oxygen forms an oxide within the raw Al-based metal powder such that a majority of the Al-based metallic particles have a particle oxygen concentration that is greater than the initial oxygen concentration of the Al-based metallic source material.

As used herein, the term “Al-based metal particle” refers to a metal particle that comprises at least 50% by weight aluminum (Al), such as at least 70% by weight Al (e.g., 75% by weight to 99% by weight aluminum, such as 90% by weight to 95% by weight aluminum). For example, such an Al-based metal particle may also include at least one additional element, such as silicon, manganese, copper, tin, zinc, titanium, zirconium, magnesium and scandium. As such, the Al-based metal particle may be an Al-based metal alloy. Other interstitial elements may be present in the Al-based metal particle, such as carbon and nitrogen.

Without wishing to be bound by any particular theory, it is believed that the addition of oxygen within the plasma atomization process impacts several properties of the resulting powder (including a majority of the particles therein), at least one of which improves the flowability of the powder. For example, the flowability of the powder can be influenced by the addition of oxygen within the plasma atomization process to impact at least one of the particle size, particle size distribution, oxygen concentration, oxygen distribution, grain size, surface roughness, etc.

In one particular embodiment, the presently presented methods may be utilized to process and recycle metal powders that are difficult to use in additive manufacturing (AM) processes and transform them into high quality powders for 3D printing applications. Thus, these methods may be used to restore the characteristics to the powders to use them in AM processes.

I. Production Methods

Apparatus and methods are generally provided for an Al-based metal powder atomization manufacturing process. In one embodiment, the method may include contacting a heated Al-based metal source with an atomization gas and an oxygen-containing gas to atomize the heated Al-based metal source to produce a raw Al-based metal powder. As such, the heated Al-based metal source is contacted with the atomizing gas and the oxygen-containing gas while carrying out the atomization process, thereby obtaining a raw Al-based metal powder comprising oxygen within the particle (i.e., having a particle oxygen concentration that is greater than the initial oxygen concentration of the Al-based metal source).

In one embodiment, the heated metal source is contacted with the atomizing gas and the oxygen-containing gas within a heat zone of an atomizer. Thus, the heated metal source contacts the plasma within the zone (with or without the oxygen-containing gas), to transform the metal source into droplets while still hot. As the droplets solidify, the metal source interacts with the oxygen (within or outside of the plasma) which results in the distribution of the oxygen into the depth of the particles.

The heated metal source may be contacted with the atomizing gas at substantially the same time as contact with the oxygen-containing gas. For example, the atomizing gas and the oxygen-containing gas may be mixed together prior to contact with the heated metal source. Alternatively, the atomizing gas and the oxygen-containing gas may be supplied separately to the heated metal source. Within the atomizing chamber, the atomizing pressure may be above atmospheric pressure (i.e., greater than 1013 mbar), such as 1050 mbar to 1200 mbar. In one particular embodiment, the atomization process may be performed in an atomizing environment that includes only the atomizing gas and the oxygen-containing gas (e.g., consists essentially of the atomizing gas and the oxygen-containing gas, with only unavoidable impurities present).

The atomizing gas may be an inert gas, such as argon. The mass flow rate used depends of the metal mass feed rate. In particular embodiments, the mass flow rate of the Al-based metal source may be 600 standard liter per minute or greater. In certain embodiments, a desired gas-to-metal ratio is maintained to ensure a desired yield of particles during the atomization.

In one particular embodiment, the oxygen-containing gas may include pure oxygen. (i.e., O₂), O₃, CO₂, CO, NO, NO₂, SO₂, SO₃, air, water vapor, or mixtures thereof. The mass flowrate injected will vary according the amount of metal injected per unit of time, reaction time and the total surface area of particles. In particular embodiments, the mass flow rate of the oxygen-containing gas may be 60 sccm or greater (standard cubic centimeter per minute).

In one embodiment, the Al-based metal source is heated prior to contact with the atomizing gas and the oxygen-containing gas. For example, the Al-based metal source may be heated to 80% of the melting point (e.g., about 85% of the melting point), which is about 660° C. for many Al-based metals. In certain embodiments, the Al-based metal source may be preheated to 525° C. or greater (e.g., 530° C. to 650° C.) Preheating the Al-based metal source allows for a relatively metal mass feed rate by lowering the amount of heat to be added to the Al-based metal source by the plasma to convert the metal to droplets. As such, each of the preheat temperature, the metal mass federate, and the temperature/power of the plasma may be controlled to produce the desired powder. For example, when the Al-based metal source is provided as a wire into a plasma atomizing process/apparatus, preheating the Al-based metal source wire to 80% of the melting point of the Al-based metal source may allow a feed rate of greater than 250 inches/minute, compared to a maximum feed rate of only about 30 inches/minute for a similar process/apparatus without any preheating.

For example, the process may be carried out using at least one plasma torch, such as a radio frequency (RF) plasma torch, a direct current (DC) or Alternative current (AC) plasma torch or a microwave (MW) plasma torch or a 3 phases plasma arc generator.

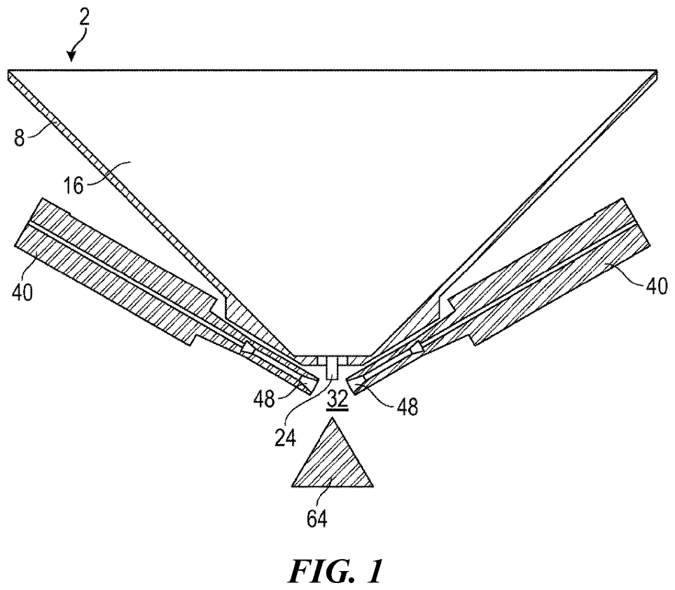

Referring now to FIG. 1, therein illustrated is a cross-section of an example of atomizing system 2. The atomizing system 2 includes a receptacle 8 that receives feed of a metal source 16 from an upstream system. For example, the feed of Al-based metal source 16 is provided as a melted stream, but it may be provided as a Al-based metal rod or Al-based metal wire as well. The Al-based metal source may be heated according to various techniques.

The heated Al-based metal source 16 is fed, through an outlet 24, into an atomization zone 32, which is immediately contacted with an atomizing fluid from an atomizing source 40. Contact of the heated Al-based metal source 16 by the atomizing fluid causes raw Al-based metal powder 64 to be formed, which is then exited from the atomization zone 32. For example, the atomizing fluid may be an atomizing gas, such as an inert gas (e.g., Ar and/or He).

It is to be understood that while an atomizing system 2 having atomizing plasma torches 40, methods and apparatus described herein for forming Al-based metal powder having improved flowability may be applied to other types of spherical powder production system, such as skull melting gas atomization process, electrode induction melting gas atomization process (EIGA process), plasma rotating electrode process, plasma (RF, DC, MW) spheroidization process, etc.

According to the illustrated example, the plasma source 40 includes at least one plasma torch. At least one discrete nozzle 48 of the at least one plasma torch 40 is centered upon the Al-based metal source feed. For example, the cross-section of the nozzle 48 may be tapered towards the Al-based metal source feed so as to focus the plasma that contacts the Al-based metal source feed. As described elsewhere herein, the nozzle 48 may be positioned so that the apex of the plasma jet contacts the Al-based metal source fed from the receptacle 8. The contacting of the Al-based metal source feed by the plasma from the at least one plasma source 40 causes the Al-based metal source to be atomized.

Where a plurality of plasma torches are provided, the nozzles of the torches are discrete nozzles 48 of the plasma torches that are oriented towards the Al-based metal source from the receptacle 8. For example, the discrete nozzles 48 are positioned so that the apexes of the plasma jet outputted therefrom contacts the Al-based metal source from the receptacle 8.

According to various exemplary embodiments for preparing spheroidal powders, the heated Al-based metal source is contact with at least one oxygen-containing gas while carrying out the atomization process. For example, the oxygen-containing gas may contact the heated metal source 16 within the atomization zone 32 of an atomizer. This atomization zone 32 is a high heat zone of the atomizer. It is above the melting point of Al-based alloys. Accordingly, the heated metal source 16 may be contacted by the atomization gas and the oxygen-containing gas at substantially the same time within the atomization zone 32.

The amount of the oxygen-containing gas to be mixed with the atomization gas may depend of the nature of the oxygen-containing gas, the total surface area of the particles being formed, reaction time and the reaction rate with the Al-based particle surface. In turn, this reaction rate may depend exponentially of the surface temperature of the particles and of the oxygen-containing gas concentration. The reaction will be more efficient at high temperature, so the concentration of the oxygen-containing gas can be adjusted accordingly to obtain the desired oxygen profile in the resulting Al-based particles. As the total surface area of Al-based metal particles increases, the total amount of oxygen atoms may be adjusted to generate the appropriate concentration profile in the surface of the particle.

The reaction between the Al-based metal particles produced from the atomization of the heated Al-based metal source and the oxygen-containing gas can take place as long as the Al-based metal particles are sufficiently hot to allow the oxygen atoms to diffuse several tens of nanometers into the surface layer of the Al-based metal particles.

It will be understood that according to various exemplary embodiments described herein, the oxygen-containing gas contacts the heated metal source during the atomization process in addition to the contacting of the heated metal source with the atomizing fluid. However, according to various exemplary embodiments described herein for producing spheroidal powders, the oxygen-containing gas for contacting the heated metal source is deliberately provided in addition to any oxygen-containing gas that could be inherently introduced during the atomization process.

According to various alternative exemplary embodiments, the atomizing fluid is an atomizing gas, which is mixed with the at least one oxygen-containing gas to form an atomization mixture. For example, the atomizing gas and the oxygen-containing gas are mixed together prior to contact with the heated metal source. The atomizing gas and the oxygen-containing gas may be mixed together within a gas storage tank or a pipe upstream of the contacting with the heated metal source. For example, the oxygen-containing gas may be injected into a tank of atomizing gas. The injected oxygen-containing gas is in addition to any oxygen-containing gas inherently present into the atomizing gas.

The amount of oxygen-containing gas contacting the heated metal source may be controlled based on desired end properties of the Al-based metal powders to be formed from the atomization process. Accordingly, the amount of oxygen-containing gas contacting the heated metal source is controlled so that the amount of atoms and/or molecules of the oxygen-containing gas contained within the Al-based metal powder is maintained within certain limits.

For example, the amount of oxygen-containing gas contacting the heated metal source may be controlled by controlling the quantity of oxygen-containing gas injected into the atomization gas when forming the atomization mixture. For example, the amount of oxygen-containing gas injected may be controlled to achieve one or more desired ranges of ratios of atomization gas to oxygen-containing gas within the formed atomization mixture.

For Al-based metal powders formed without the addition of an oxygen-containing gas, it was observed that Al-based metal powders having various different particle size distributions and that had undergone sieving and blending steps did not always flow sufficiently to allow measurement of their flowability in a Hall flowmeter (see FIG. 1 of ASTM B213-17). For example, Al-based metal powder falling within particle size distributions between 10-53 μm did not flow in a Hall flowmeter according to ASTM B213-17.

In an effort to further increase the flowability of Al-based metal powder, the static electricity may be decreased. The sieving, blending and manipulation steps may cause particles of the Al-based metal powder to collide with one another, thereby increasing the level of static electricity. This static electricity further creates cohesion forces between particles, which causes the Al-based metal powder to flow poorly.

The raw Al-based metal powder formed from atomizing the heated metal source by contacting the heated metal source with the atomization gas and the oxygen-containing gas is further collected. The collected raw Al-based metal powder contains a mixture of metal particles of various sizes. The raw Al-based metal powder is further sieved so as to separate the raw Al-based metal powder into different size distributions, such as 10 μm to 45 μm, 15 μm to 45 μm, 10 μm to 53 μm, 15 μm to 63 μm, 20 μm to 63 μm, 15 μm to 53 μm, 45 μm to 106 μm, and/or 25 μm to 45 μm. As such, the raw Al-based metal powder may be sieved to obtain a powder having predetermined particle size.

It was observed that Al-based metal powders formed according to various exemplary atomization methods described herein in which the heated metal source is contacted with the oxygen-containing gas exhibited substantially higher flowability than Al-based metal powders formed from an atomization methods without the contact of the oxygen-containing gas. This difference in flowability between metal powders formed according to the different methods can mostly be sized in metal powders having the size distributions of 10 μm to 45 μm, 15 μm to 45 μm, 10 μm to 53 μm, 15 μm to 63 μm, 20 μm to 63 μm, 15 μm to 53 μm, 45 μm to 106 μm, and/or 25 μm to 45 μm or similar particle size distributions. However, it will be understood that metal powders in other size distributions may also exhibit slight increase in flowability when formed according to methods that include contact of the heated metal source with the oxygen-containing gas.

Without being bound by the theory, from contact of the heated Al-based metal source with the oxygen-containing gas during atomization, atoms and/or molecules of the oxygen-containing gas react with particles of the Al-based metal powder as these particles are being formed. Accordingly, oxides are formed within the thickness of the particles, with a concentration that is generally depleting into the thickness of the particles of the Al-based metal particle. This oxygen concentration is thicker and deeper in the surface than usual native oxide layer. For example, the compound of the heated metal with the oxygen-containing gas in the depleted layer is at least one metal oxide. Since the atoms of the oxygen-containing gas are depleting through the thickness of the surface layer, it forms a non-stoichiometric compound with the metal as concentration is depleting.

II. Particle Size and Flowability

Metal powders having fine particle sizes, such within a size distribution below 106 μm, possess more surface area and stronger surface interactions, which result in poorer flowability behavior than coarser powders. The flowability of a powder depends on one or more of various factors, such as particle morphology, particle size distribution, surface smoothness, moisture level, satellite content and presence of static electricity. The flowability of a powder is thus a complex macroscopic characteristic resulting from the balance between adhesion and gravity forces on powder particles. Unless otherwise stated herein, the flowability of the Al-based metal powder is expressed according to the measurement according to ASTM B213-17, which is titled “Standard Test Methods for Flow Rate of Metal Powders Using the Hall Flowmeter Funnel.” The flowability of the Al-based metal powder is based on measured dried powder.

As stated, it is believed that the addition of oxygen within the plasma atomization process impacts several properties of the resulting powder (including a majority of the particles therein), at least one of which improves the flowability of the powder at various particle size distributions. As used herein, the “Hall flowability” refers to the time (expressed in seconds) that the tested powder flows according to ASTM B213-17. As used herein, the “Carney flowability” refers to the time (expressed in seconds) that the tested powder flows according to ASTM B964-16. In either test, the lower the measured time to complete the flowability test, the better the tested sample flows. If a tested sample cannot complete a given flow test, then that sample “does not flow” meaning that all of the tested sample did not pass through the testing device.

In one embodiment, for example, the Al-based metal powder has a particle size distribution of 15 to 45 μm with a Hall flowability of 240 sec or less (e.g., 200 seconds or less, such as 120 seconds to 200 seconds). In this embodiment, the Al-based metal powder having a particle size distribution of 15 to 45 μm may have a Carney flowability 75 sec or less (e.g., 60 seconds or less, such as 45 seconds to 60 seconds).

In one embodiment, for example, the Al-based metal powder has a particle size distribution of 15 to 53 μm with a Hall flowability of 180 sec or less (e.g., 160 seconds or less, such as 120 seconds to 160 seconds). In this embodiment, the Al-based metal powder having a particle size distribution of 15 to 53 μm may have a Carney flowability 30 sec or less (e.g., 20 seconds to 30 seconds).

In one embodiment, for example, the Al-based metal powder has a particle size distribution of 15 to 63 μm with a Hall flowability of 100 sec or less (e.g., 90 seconds or less, such as 60 seconds to 90 seconds). In this embodiment, the Al-based metal powder having a particle size distribution of 15 to 63 μm may have a Carney flowability 45 sec or less (e.g., 25 seconds to 40 seconds).

In one embodiment, for example, the Al-based metal powder has a particle size distribution of 25 to 45 μm with a Hall flowability of 75 sec or less (e.g., 65 seconds or less, such as 50 seconds to 65 seconds). In this embodiment, the Al-based metal powder having a particle size distribution of 25 to 45 μm may have a Carney flowability 20 sec or less (e.g., 10 seconds to 15 seconds).

In one embodiment, for example, the Al-based metal powder has a particle size distribution of 45 to 106 μm with a Hall flowability of 60 sec or less (e.g., 45 seconds or less, such as 30 seconds to 45 seconds). In this embodiment, the Al-based metal powder having a particle size distribution of 45 to 106 μm may have a Carney flowability 15 sec or less (e.g., 12 seconds or less, such as 7 seconds to 12 seconds).

III. Oxygen Concentration and Oxygen Distribution

Due to the addition of the oxygen in the atomization process, the raw Al-based metallic particles have a total particle oxygen concentration that is greater than the initial oxygen concentration of the Al-based metallic source material.

For example, the initial oxygen concentration of the Al-based metallic source material may be less than 10 parts per million (ppm) by weight, such as less than 5 ppm by weight. For example, the Al-based metallic source material may have an initial oxygen concentration that is generally limited to an incidental amount of oxygen. After atomization within the presence of an oxygen-containing gas, the raw Al-based metallic powder may have a particle oxygen concentration that is greater than 30 ppm by weight (e.g., greater than 35 ppm by weight, such as greater than 40 ppm by weight). In one embodiment, the raw Al-based metallic powder may have a maximum particle oxygen concentration that is within the accepted range of oxygen for the given source material concentration. For example, the raw Al-based metallic powder may have a particle oxygen concentration that is 100 ppm to 1000 ppm by weight, such as 200 ppm to 800 ppm by weight (e.g., 300 ppm to 600 ppm by weight).

In particular embodiments, the oxygen concentration is diffused within the depth of the Al-based metallic particles with the oxygen concentration changing throughout the depth of the particle (e.g., decreasing into the depth of the particle). Generally, the Al-based metallic powder may have some variance of oxygen concentration between individual particles due to the continuous nature of the atomization process. For example, the powder may be divided into portions with similar characteristics but some variance of particular properties (e.g., oxygen concentration and/or oxygen diffusion). As discussed below, the portion (e.g., a first portion) of the powder may be described with the particularly desired characteristics and properties. For example, the portion of the Al-based metallic particles may constitute at least 40% by weight of the plurality of Al-based metallic particles of the metallic powder (e.g., at least 50% by weight of the plurality of Al-based metallic particles of the metallic powder, such as 50% to 99% of the plurality of Al-based metallic particles of the metallic powder, such as 60% to 95% of the plurality of Al-based metallic particles of the metallic powder).

In particular embodiments, a portion of the Al-based metallic particles (e.g., a majority of the Al-based metallic particles by volume) may have an oxygen concentration that decreases into the thickness of individual particles. For example, each particle of the portion of the Al-based metallic particles may have a half oxygen concentration is measured at a sputtering time that is 2.8 minutes or greater (e.g., 3.0 minutes to 4.5 minutes), as measured via Auger Electron Spectroscopy according to the process detailed below. As used herein, the “half oxygen concentration” refers to 50% of the maximum oxygen concentration.

It is recognized that the amount of oxygen within the particles may vary with the particle size of the particles. When normalized to the size of the particle (using the particle surface area), each particle of the portion of the Al-based metallic particles may have a normalized half oxygen concentration is measured at a sputtering time that is 0.002 min/μm² or greater, as measured via Auger Electron Spectroscopy (e.g., 0.002 min/μm² to 0.003 min/μm²). These values may be restated in seconds/μm² by multiplying by 60. As such, each particle of the portion of the Al-based metallic particles may have a normalized half oxygen concentration is measured at a sputtering time that is 0.12 seconds/μm² or greater, as measured via Auger Electron Spectroscopy (e.g., 0.12 seconds/μm² to 0.18 seconds/μm²). As shown in the exemplary powder discussed below in the Examples, the exemplary P.A. powder (formed with oxygen presence in the plasma atomization process) showed greater normalized half oxygen concentration when compared to the comparative P.A. powder and the comparative G.A. powder.

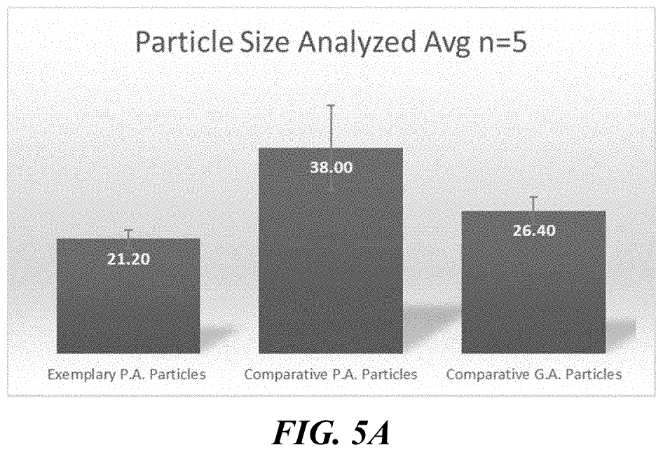

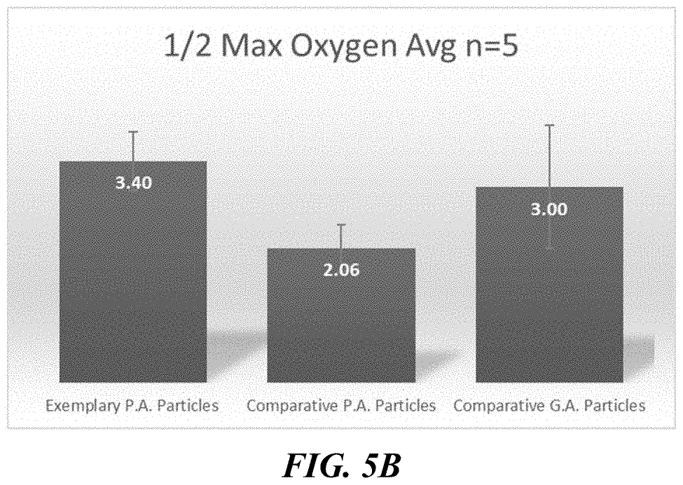

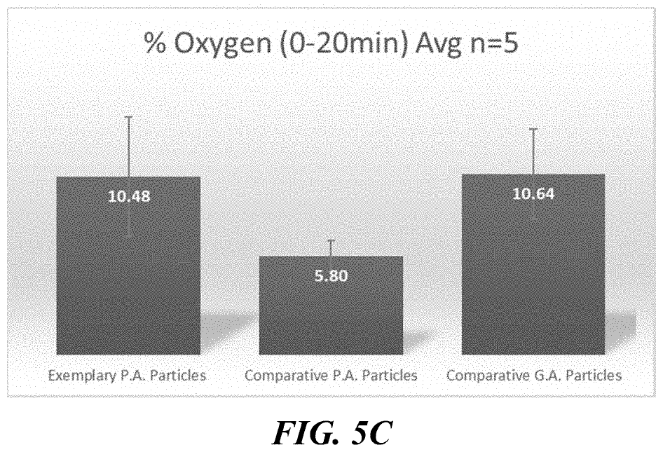

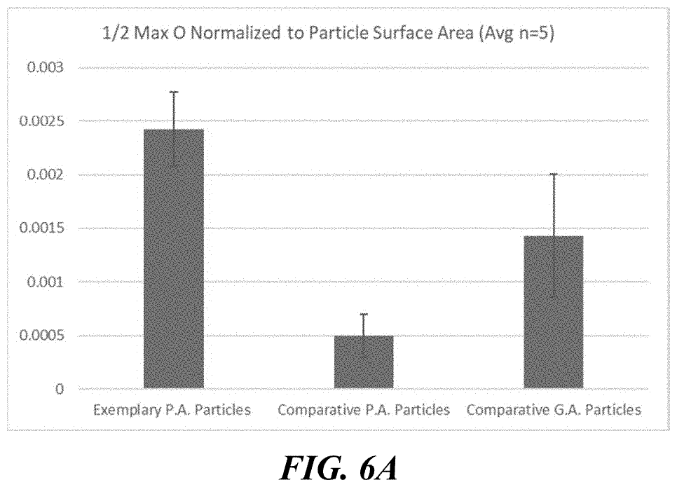

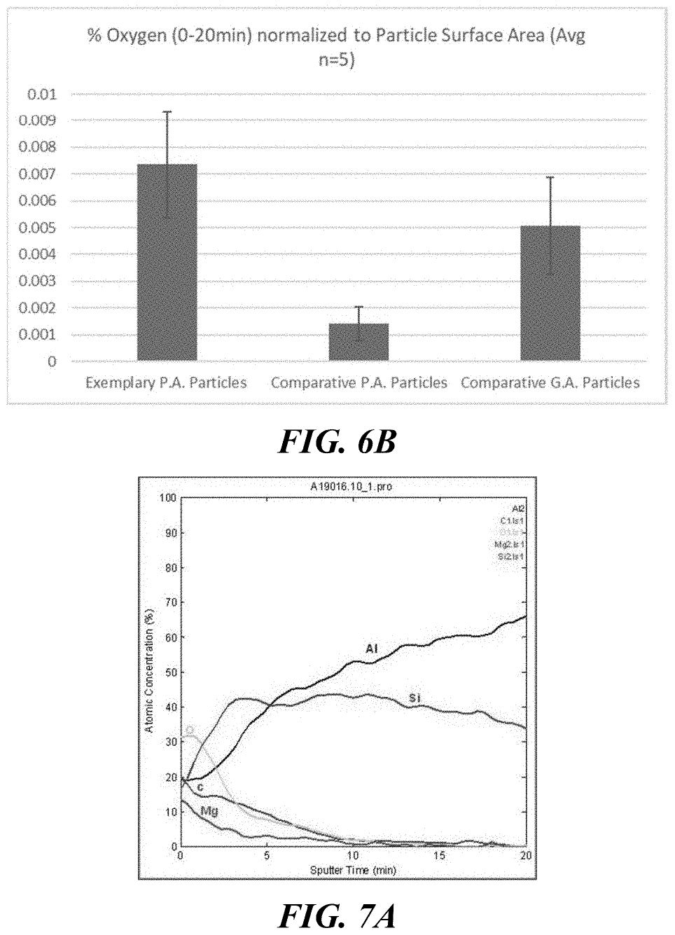

A larger ratio means that there is a larger oxide thickness (and pick-up) for same particle size. An index is calculated for area by dividing time by πD² to show the impact of the particle size on area. For example, the normalized index shown in FIGS. 6A and 6B were respectively obtained by dividing the respective values of FIG. 5B and FIG. 5C by the surface area of particle (i.e., 4πr²=πD²) with D is the average diameter of the particle analyzed by AES in FIG. 5A. The ratio obtained in FIG. 6A has thus the unit of min/μm² and the ratio obtained in FIG. 6B has the unit of %/μm².

Similarly, each particle of the portion of the Al-based metallic particles may have an oxygen concentration that is expressed as a charted area under an oxygen concentration curve plotted, as measured via Auger Electron Spectroscopy according to the process detailed below, with the charted area being greater than 7.5% for a sputtering time of 20 minutes (e.g., greater than 8% for a sputtering time of 20 minutes, such as 8.5% for a sputtering time of 20 minutes).

When normalized to the size of the particle, each particle of the portion of the Al-based metallic particles may have a normalized charted area of 7.5%/μm² or greater, as measured via Auger Electron Spectroscopy for a sputtering time of 20 minutes.

In certain embodiments, a portion of the Al-based metallic particles (e.g., a majority of the Al-based metallic particles by volume) may have an oxygen concentration that has its maximum at its surface of the particles. In alternative embodiments, a portion of the Al-based metallic particles (e.g., a majority of the Al-based metallic particles by volume) may have an oxygen concentration having its maximum at a depth of 2 nm to 10 nm from the surface of the particle, as measured via Auger Electron Spectroscopy according to the process detailed below.

IV. Grain Size, Surface Properties, and Porosity

Without wishing to be bound by any particular theory, it is believed that the exothermic reaction between oxygen and aluminum during the atomization process increases the surface temperature and/or slow the cooling rate of the particles to result in larger grain sizes within the particles as well as a smoother particle surface (i.e., less surface roughness). Additionally, the porosity within the particles may be minimized.

In particular embodiments, the average grain area fraction of each particle within a portion of the Al-based metal powder is 75% or greater (e.g., 77.5% to 90%), calculated by the ratio of area of the dark phase (i.e., the grain) to the total area.

Conversely, the average area fraction for eutectic (i.e., the material between the grains) of each particle within a portion of the Al-based metal powder is 25% or less (e.g., 20% or less), calculated by the ratio of area of the bright phase (i.e., the eutectic) to the total area.

In particular embodiments, the average porosity of each particle within a portion of the Al-based metal powder is 0.20% by volume or less (e.g., 0.15% by volume or less), calculated by the ratio of area of the pores to the total area.

### Auger Electron Spectroscopy

Auger electron spectroscopy (AES) was used to examine the surface chemistry of individual Al-based powder particles (e.g., AlSi₇Mg powder particles). Of particular interest was the thickness of the surface oxide layer. As used herein, the term “as measured by auger electron spectroscopy” refers to the conditions used to collect this data in the Physical Electronics (PHI) Auger 700Xi instrument using the following conditions:
At a vacuum of 8×10¹⁰ Torr base pressure or lower pressure in the analysis chamber.
Electron beam: 20 kV, 5 nA.
Argon ion sputtering beam: 2 kV, 1 μA, 3×3 mm raster area, 0.3 minute sputter interval, 30° stage tilt from the electron beam (using a reference material of SiO₂ providing a sputter rate of 12 Å/minute for a thermally grown SiO₂ layer on a silicon wafer).
Auger detection limits: 0.5 atom percent.
Raw peak intensities were converted to atomic percent using sensitivity factors supplied from Physical Electronics (PHI). Errors in the calculated atomic concentrations are unknown but the values can be used for comparisons between analysis locations and samples.

Small amounts of powder were adhered to pieces of clean silicon wafer using a drop of acetone/scotch tape sticky residue. Excess and loose powder was removed using canned air. The pieces of silicon were mechanically mounted to standard PHI sample mounts and introduced to the analysis chamber.

Secondary electron images and Auger depth profiles were collected from several powder particles within the field of view at magnifications of 250× to 500×. For the depth profiles, the electron beam was held fixed on selected particles. Although unknown, it is estimated that the spot size for the 20 kV, 5 nA electron beam would be in the 20 nm to 50 nm range for these materials.

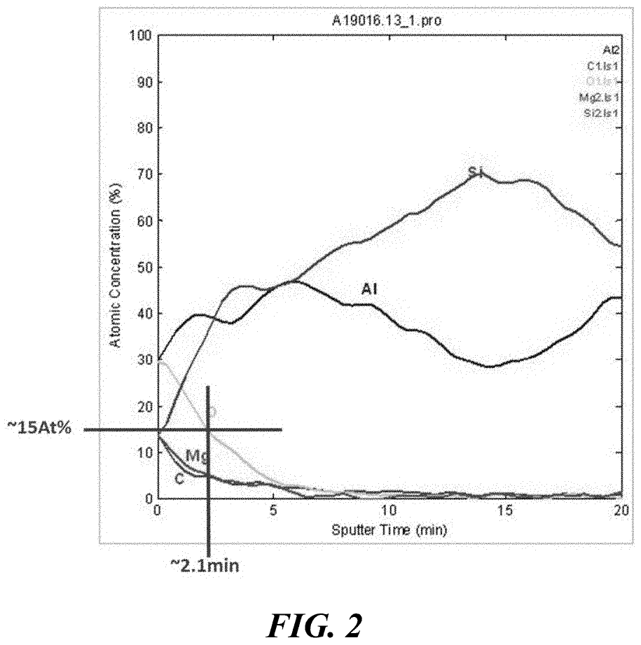

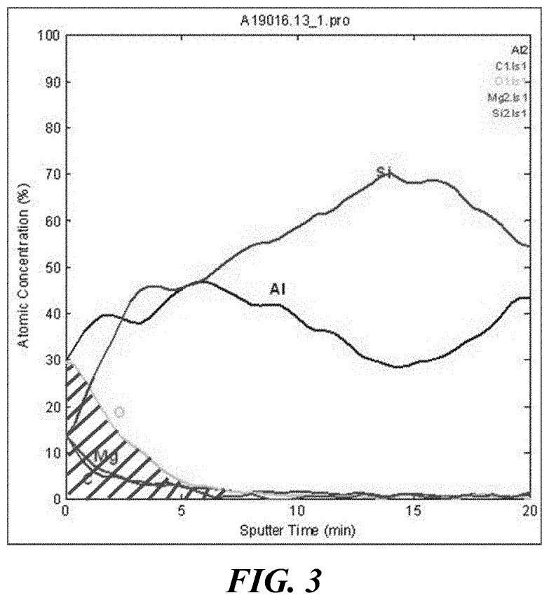

Two methods are presented to compare surface oxide on the particles examined: (1) the sputter time to reach ½ the maximum oxygen level (this is considered to be the time to reach the interface between the surface oxide and bulk particle) as shown in FIG. 2 and (2) the average oxygen signal from 0 to 20 minutes as shown in FIG. 3.

FIG. 2 shows that the maximum oxygen for this exemplary profile is just under 30 At %. The interface between the surface oxide and substrate is considered to be when the oxygen signal goes to ½ the maximum which for this particle is just under 15 At %. The sputter time to reach that concentration was 2.1 minutes.

FIG. 3 shows the average oxygen (area under the oxygen profile, represented with the slashed lines) for this depth profile. This average oxygen is calculated by summing the % oxygen measured for each sputter cycle from 0 to 20 min and then dividing by the number of cycles in this time period.

### Exemplary Plasma Atomized Powder with Oxygen

An Al-based metal powder was produced by plasma atomization using an atomizing gas that was a high purity argon (>99.997%). Oxygen (O₂) was injected to the high purity argon to form an atomization mixture of 252 ppm of oxygen within the argon. A heated Al-based metal source was contacted with the atomization mixture during the atomization process.

After formation, the raw Al-based metal powder was sieved to isolate the 15-53 μm particle size distributions. The sieved powder was then mixed to ensure homogeneity.

### Comparative Plasma Atomized Powders

Commercially available plasma atomized particles were purchased, and the powder properties were analyzed.

### Comparative Gas Atomized Powders

Commercially available gas atomized particles were purchased, and the powder properties were analyzed.

### Flowability Results

Powders were tested for flowability from each of the exemplary PA powder according to an embodiment described herein, the comparative PA powder purchased commercially, and the comparative gas atomized powder. Only the exemplary PA powder, formed according to an embodiment described above, showed good flowability. The comparative PA powder, which was commercially purchased, showed bad flowability.

Additional tests were performed using ASTM B213-20 for the Hall flowability testing with a quantity used to measure time being 50 g on particles formed from Al-10Si—Mg. The results showed that particles in the range of 20 μm to 75 μm had a Hall flowability (ASTM B213-20) of 72 and a Carney flowability of 14.5 seconds. The results showed that particles in the range of 20 μm to 63 μm had a Hall flowability (ASTM B213-20) of 63 and a Carney flowability of 12.6 seconds.

### AES Data

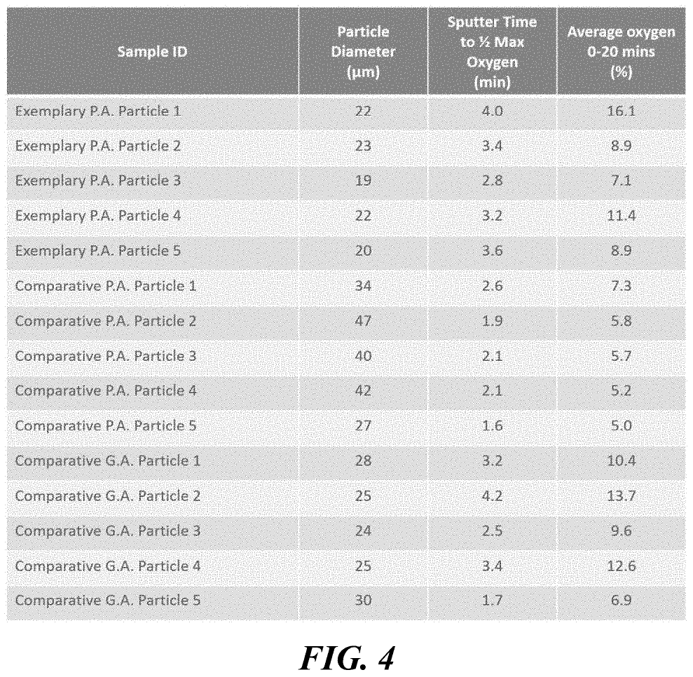

FIG. 4 shows a table summarizing the particle diameter, sputter time to reach ½ the maximum oxygen concentration (interface between the surface oxide and underlying substrate) and the average oxygen % from 0 to 20 minute. Five particles were examined for each sample from the exemplary PA powder according to an embodiment described herein, the comparative PA powder purchased commercially, and the comparative gas atomized powder.

The particle sizes analyzed varied between the three powders, as shown in FIGS. 5A, 5B, and 5C. The surface area of each particle was calculated and the ½ Max O and % Oxygen was then normalized to the particle surface area, as shown in FIGS. 6A and 6B.

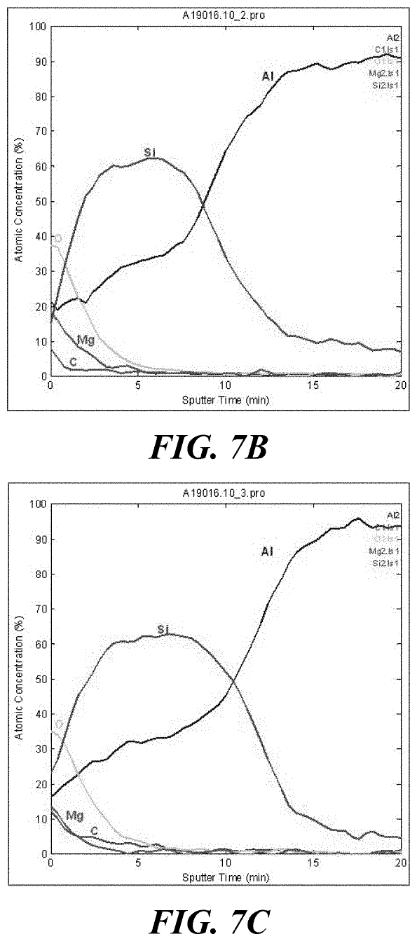

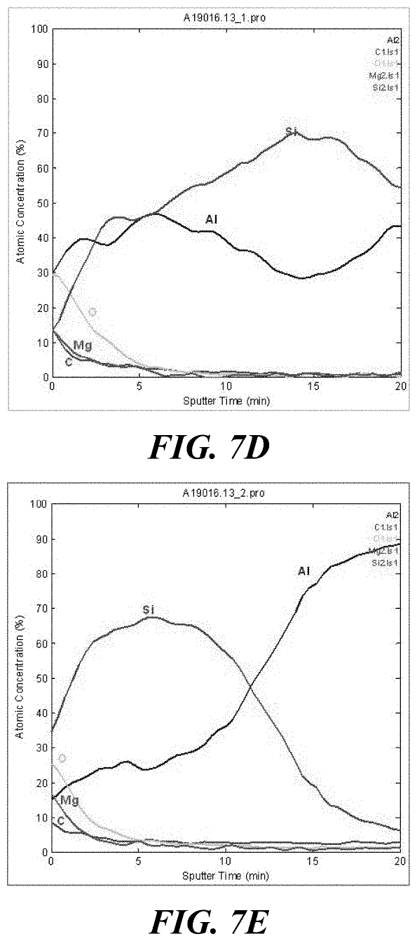

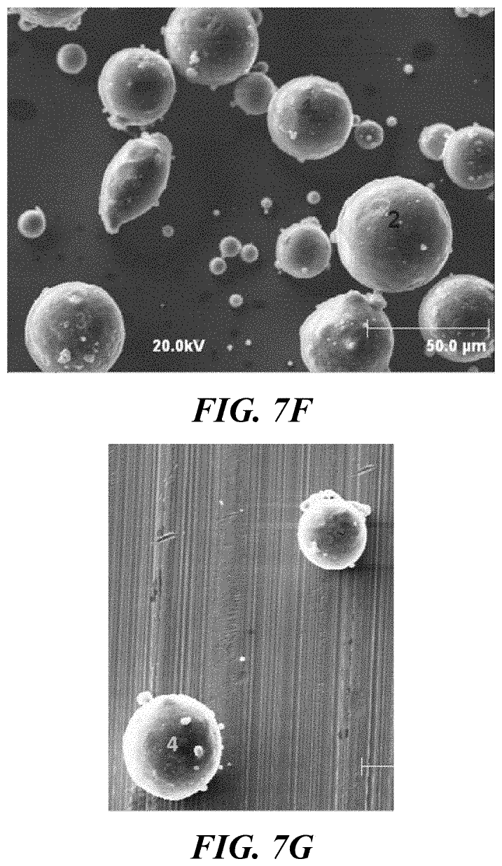

FIGS. 7A, 7B, 7C, 7D, 7E show the AES data for the five labeled particles in the SEM images shown in FIGS. 7F and 7G of the exemplary PA powder.

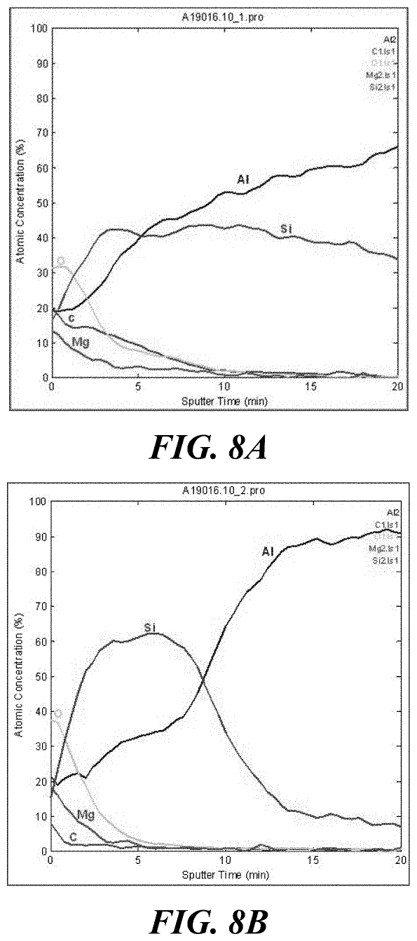

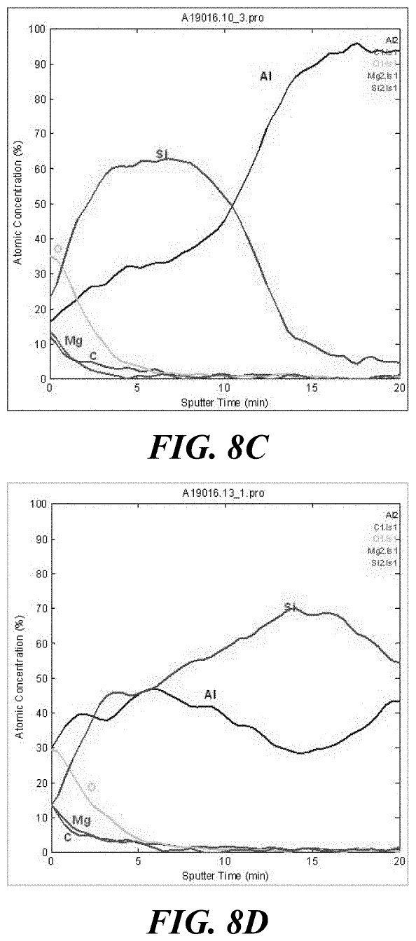

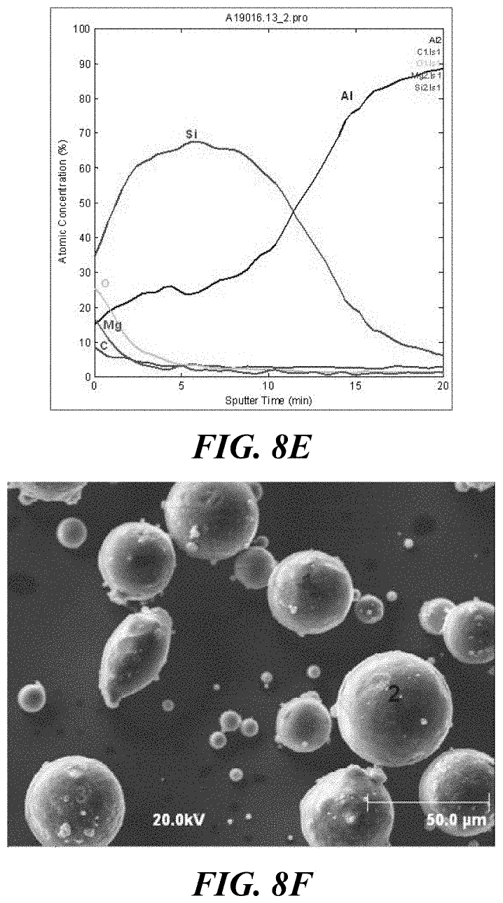

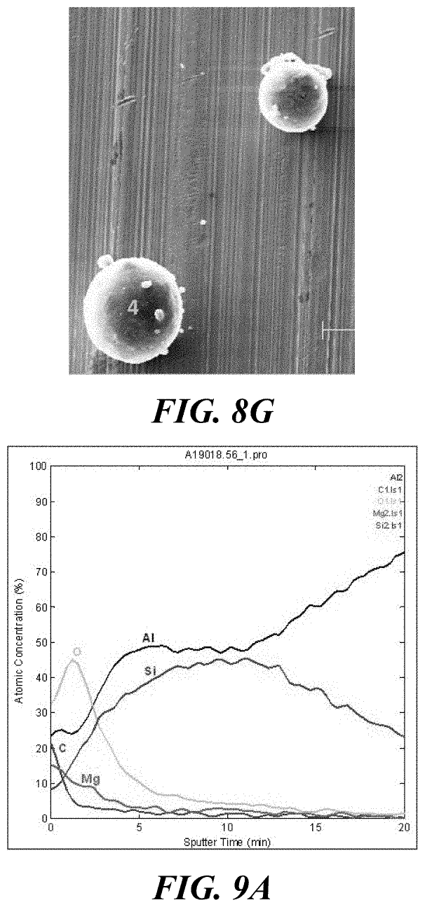

FIGS. 8A, 8B, 8C, 8D, 8E show the AES data for the five labeled particles in the SEM images shown in FIGS. 8F and 8G of the comparative PA powder.

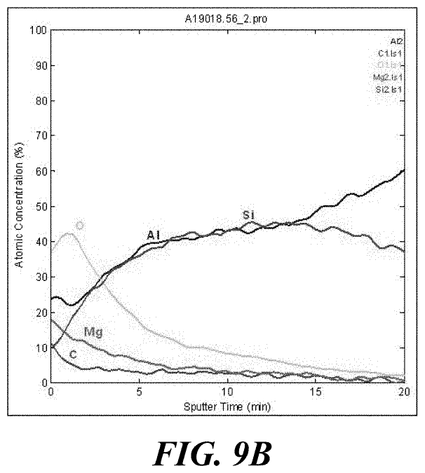

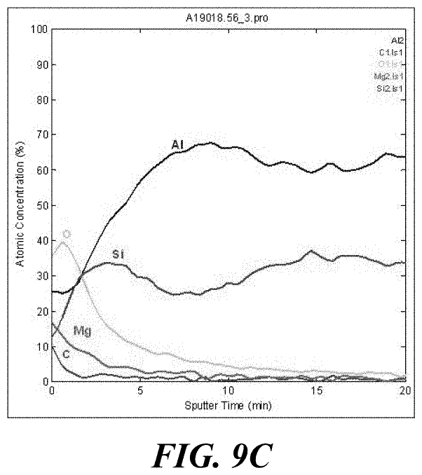

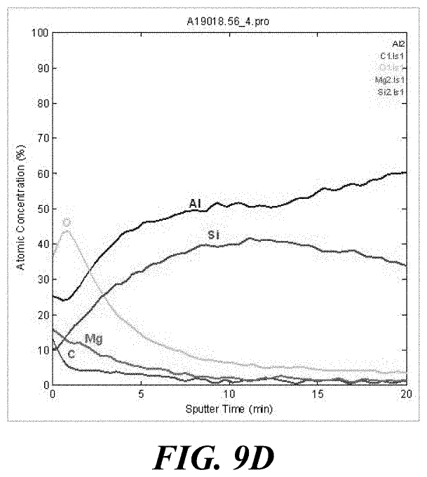

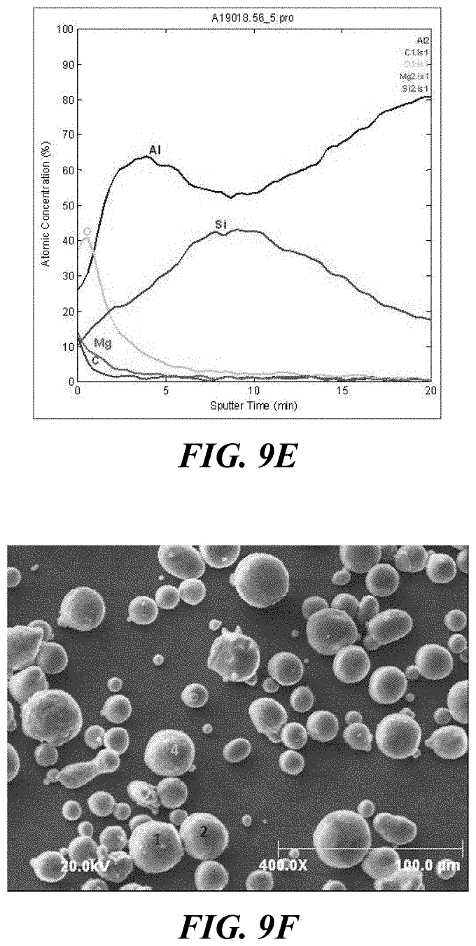

FIGS. 9A, 9B, 9C, 9D, 9E show the AES data for the five labeled particles in the SEM images shown in FIG. 9F of the comparative GA powder.

### Image Analysis

30 high resolution back-scattered electron images of individual powder particles were analyzed from the 3 powders: the exemplary PA powder according to an embodiment described herein, the comparative PA powder purchased commercially, and the comparative gas atomized powder.

Image analysis was conducted using a combination of “Trainable Weka Segmentation” (Arganda-Carreras, I.; Kaynig, V. & Rueden, C. et al. (2017), “Trainable Weka Segmentation: a machine learning tool for microscopy pixel classification.”, Bioinformatics (Oxford Univ Press) 33 (15), PMID 28369169, doi:10.1093/bioinformatics/btx180) and data processing in Python to determine grain size distributions for each data.

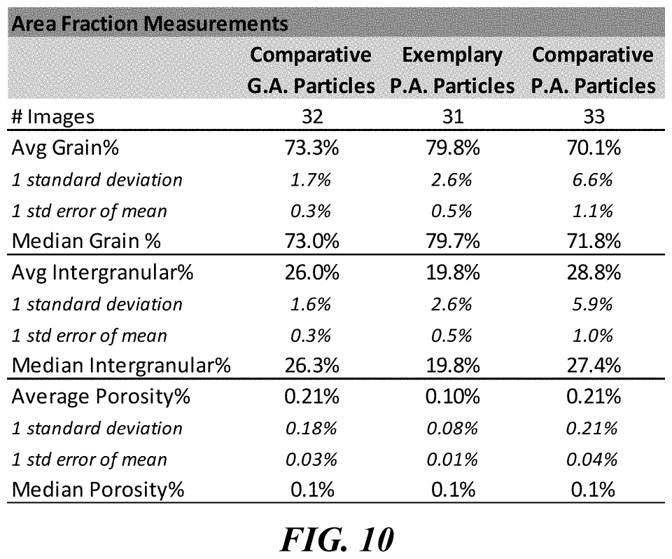

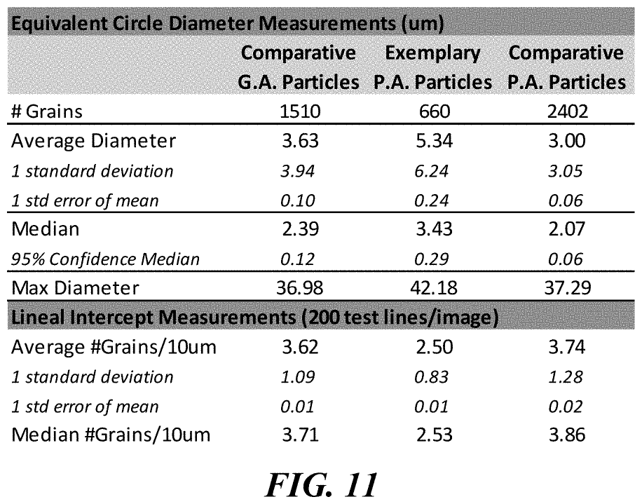

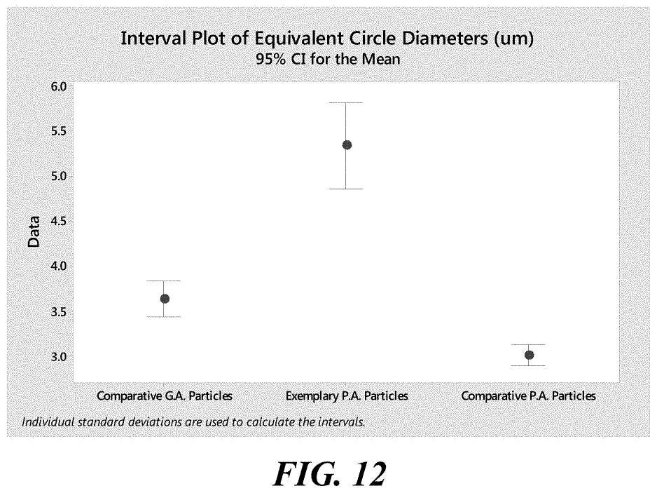

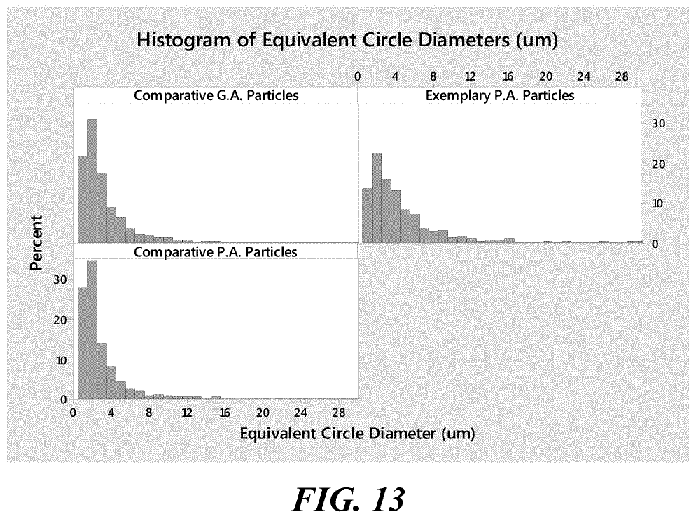

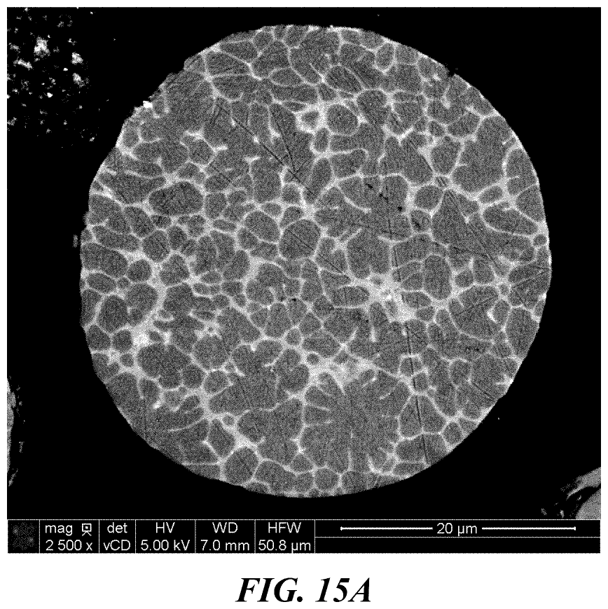

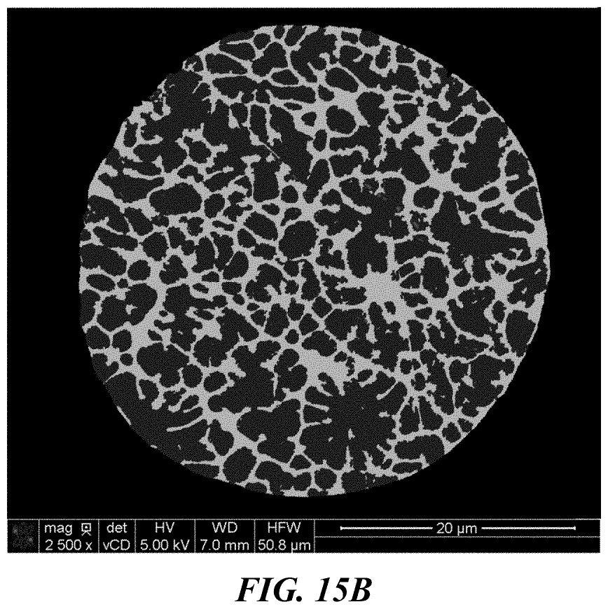

Equivalent circle diameters (in micrometers) are reported for the grain size distributions. FIG. 10 shows the area fraction measurements, and FIG. 11 shows the equivalent circle diameter measurements (μm) and lineal intercept measurements (process described below). FIG. 12 shows the average grain size of these powders. FIG. 15 shows a histogram of the powders.

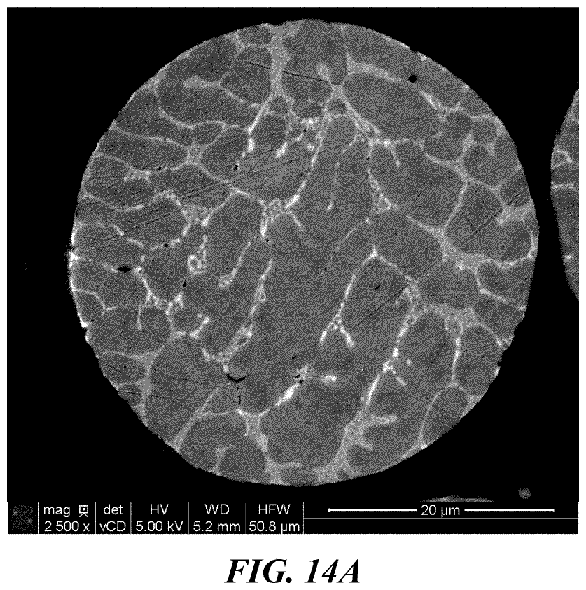

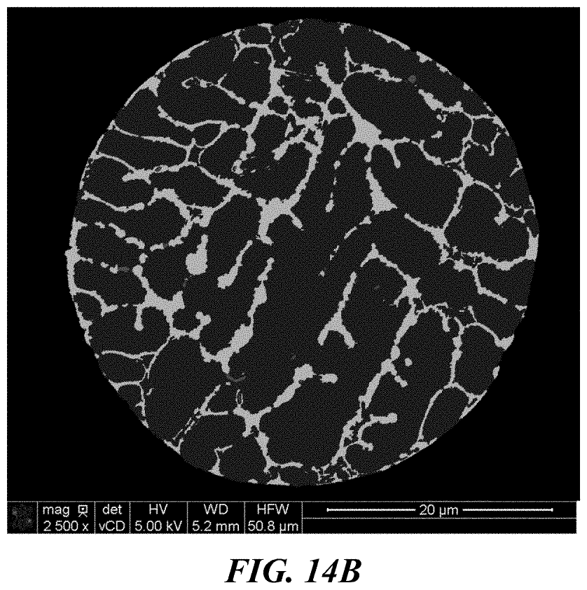

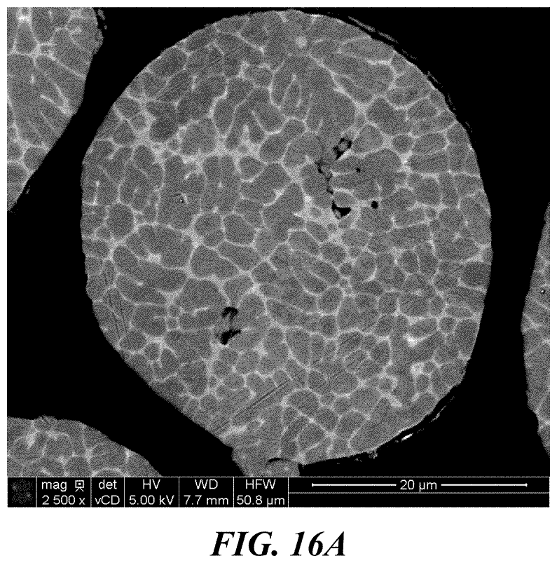

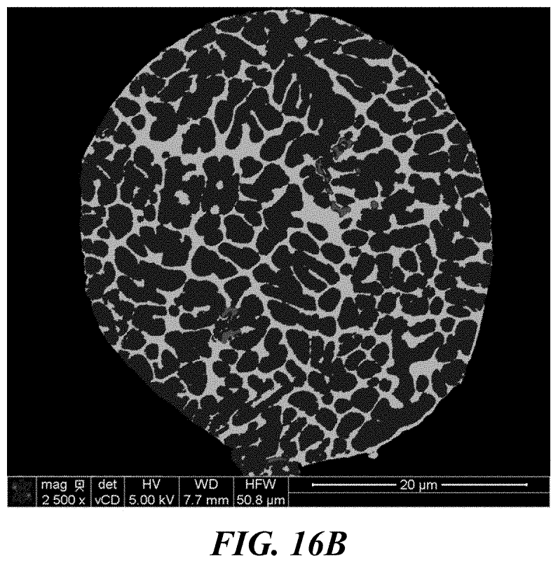

FIG. 14A shows a back-scattered electron image of an exemplary PA particle. FIG. 15 shows a back-scattered electron image of a particle from the comparative PA powder. FIG. 16A shows a back-scattered electron image of a particle from the comparative GA powder.

Each of these back-scattered electron images were processed using ImageJ 1.52p (FIJI) to convert them into 8-bit grayscale images (tifs). The images were processed to normalize the contrast for each image using enhance contrast function, resulting in FIGS. 14B, 15B, and 16B, respectively.

24 random images were selected to create segmentation model using Trainable WEKA Segmentation plugin (v3.2.33) [Arganda-Carreras, I.; Kaynig, V.; Rueden, C. et al. (2017) Trainable Weka Segmentation: a machine learning tool for microscopy pixel classification.” Bioinformatics (Oxford Univ Press) 33 (15), PMID 28369169, doi:10.1093/bioinformatics/btx180], with Model settings of:
Field of view: max sigma=16.0, min sigma=0.0
Membrane thickness: 1, patch size: 19
3 classes: grain, interdendrite, pore
FastRandomForest model with features: Gaussian blur, Sobel filter, Hessian, Difference of gaussians, Membrane projections, Variance,
Mean, Median (92 total attributes used)

The segmented RGB images were turned into grayscale for python.

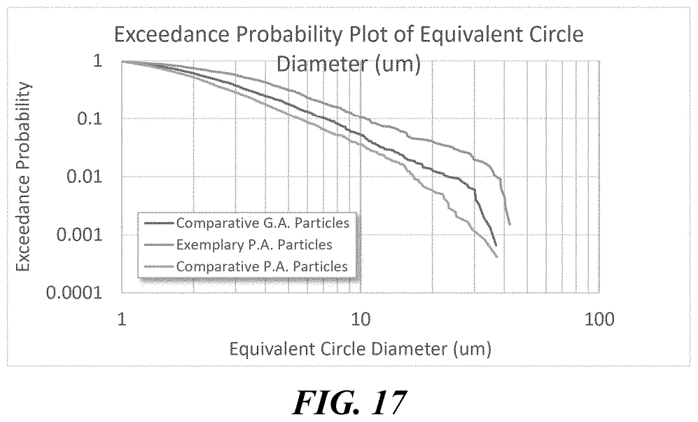

FIG. 17 shows the Grain Size Distribution of the three powders.

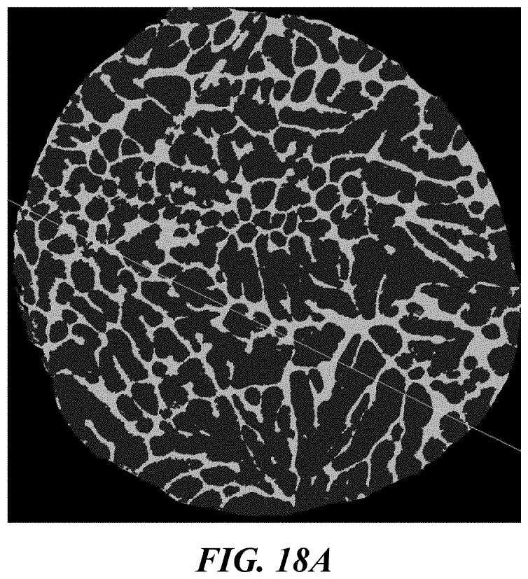

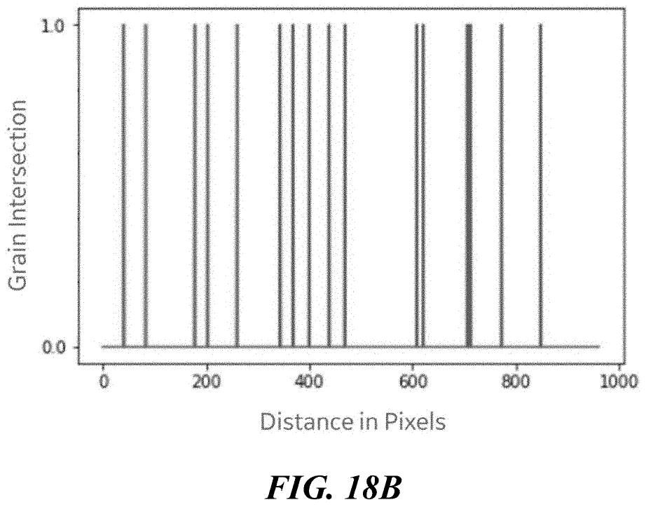

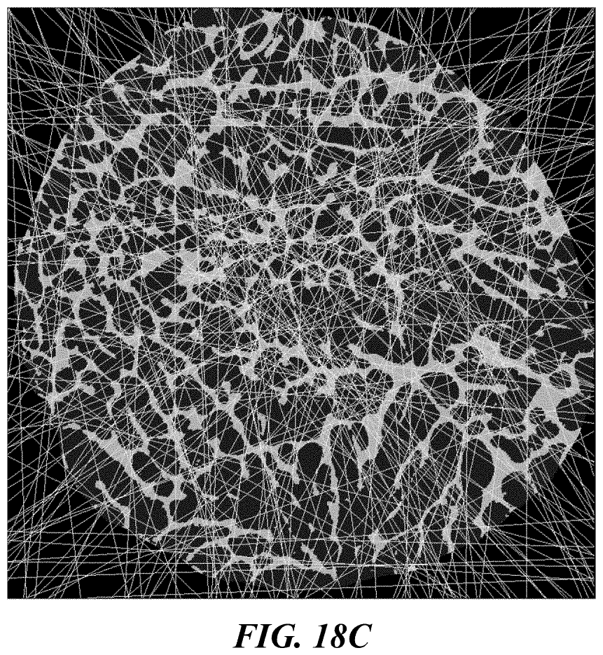

The number of grains were measured using a Lineal Intercept Measurements, where FIGS. 18A-18C show an example of the procedure described herein, where processing of the Segmented images from 1(d) using Python (3.7.3) with additional libraries used being OpenCV (3.4.1), NumPy (1.16.2), MatPlotLib (3.0.3), Scikit-image (0.14.2), Scipy (1.2.1). The process involved:

Cropping the SEM label off of image to process only the segmented region;

Restricting the analyses to central particle by masking region of interest;

Performing morphological closing on the intergranular region mask to remove small holes (kernel=3×3 of unit 1);

Removing grains smaller than 300 pixels (determined using connectivity=4);

Determining area fractions of phases based on total area of central particle;

Identifying and calculating equivalent circle diameters of individual grains;

Performing intercept procedure on 200 random test lines per image to determine number of grain intersections per unit length [based on ASTM E112-13, Standard Test Methods for Determining Average Grain Size, ASTM International, West Conshohocken, Pa., 2013, www.astm.org]. Each intercept was counted once upon crossing a grain boundary to enter a grain.

The test region was cropped to a rectangle encompassing only the particle of interest and the statistics were determined on grain size, area fraction, and test lines for entire data set. The area fractions of Grains, Intergranular Regions, and Pores for all images were aggregated to determine average, standard deviation, standard error of the mean, and median values. The equivalent circle diameters for all particles were aggregated over all images to obtain a sample distribution. The average, standard deviation, standard error of the mean, median, and maximum values were calculated from this distribution. The average lineal intercept per pixel unit from 200 random test lines are calculated per image. These average intercepts/pixel were aggregated for all images to calculate average, standard deviation, standard error of the mean, and median values. The intercepts/pixel values were multiplied by the pixel scale factor (pixels/μm) to convert measurements into physical units.

The exemplary PA powders, the comparative PA powders, and comparative GA powders were tested with 200 random lines/image, which shows that the exemplary PA particles (from the exemplary PA powders) have much less intercepts (meaning larger grains). For example, the exemplary PA powders formed according to embodiments of the present disclosure may have an average of grains/10 μm of line of less than 3.5, such as less than 3 (e.g., 2 to 3). Similarly, the exemplary PA powders formed according to embodiments of the present disclosure may have a median average of grains/10 μm of line of less than 3.5, such as less than 3 (e.g., 2 to 3).

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed:

1. A metallic powder comprising a plurality of Al-based metallic particles comprising at least 50% by weight aluminum, wherein the plurality of Al-based metallic particles comprises a first portion of Al-based metallic particles, wherein the first portion of Al-based metallic particles comprises a normalized half oxygen concentration that is 50% of a normalized maximum oxygen concentration, wherein the normalized half oxygen concentration to particle surface area is 0.002 min/μm² or greater as measured via auger electron spectroscopy.

2. The metallic powder of claim 1, wherein the first portion of the Al-based metallic particles constitutes at least 40% by weight of the plurality of Al-based metallic particles of the metallic powder.

3. The metallic powder of claim 1, wherein the first portion of the Al-based metallic particles constitutes 50% to 99% of the plurality of Al-based metallic particles of the metallic powder.

4. The metallic powder of claim 1, wherein the normalized half oxygen concentration to particle surface area is 0.002 min/μm² to 0.003 min/μm² as measured via auger electron spectroscopy.

5. The metallic powder of claim 1, wherein each Al-based metallic particle of the first portion of Al-based metallic particles have an average porosity of 0.2% or less.

6. The metallic powder of claim 1, wherein the first portion of Al-based metallic particles has an average grain fraction measurement of 75% or greater.

7. The metallic powder of claim 1, wherein a majority of the particles within the plurality of Al-based metallic particles have an average of grains/10 μm of line of less than 3.5 as measured according to a lineal intercept measurement.

8. The metallic powder of clause 1, wherein a majority of the particles within the plurality of Al-based metallic particles have an average of grains/10 μm of line of 2 to 3 as measured according to a lineal intercept measurement.

9. The metallic powder of claim 1, wherein the metallic powder comprises at least 70% by weight Al.

10. The metallic powder of claim 1, wherein the metallic powder comprises 75% by weight to 99% by weight aluminum.

12. The metallic powder of claim 1, wherein each Al-based metallic particle of the first portion of Al-based metallic particles comprises a surface layer comprising oxygen and nitrogen enriched layers.

13. The metallic powder of claim 1, wherein the metallic powder is a plasma atomized metallic powder.

14. The metallic powder of claim 1, wherein the oxygen is present in each Al-based metallic particle of the first portion of Al-based metallic particles as an oxide.

15. The metallic powder of claim 14, wherein the oxide comprises silicon oxide, an aluminum oxide, a magnesium oxide, or a mixture thereof.

16. The metallic powder of claim 1, wherein the Al-based metal powder has a particle size distribution of 15 to 53 μm and Hall flowability of 180 sec or less.

17. The metallic powder of claim 1, wherein the Al-based metal powder has a particle size distribution of 15 to 63 μm and a Hall flowability of 100 sec or less.

18. A method of forming a metal powder of Al-based metallic particles, comprising:
supplying an Al-based source metal into a heat zone of an atomizer such that Al-based metallic particles are formed in a plasma field, wherein the Al-based metallic source material comprises at least 50% by weight aluminum and has an initial oxygen concentration; and
supplying oxygen into the atomizer such that a majority of the Al-based metallic particles have a particle oxygen concentration that is greater than the initial oxygen concentration of the Al-based metallic source material.

19. The method of claim 1, wherein the initial oxygen concentration is less than 10 ppm by weight, and wherein the particle oxygen concentration is greater than 30 ppm by weight.

20. An Al-based metal powder atomization manufacturing process comprising:
atomizing a heated Al-based metal source to produce a raw Al-based metal powder;
contacting said heated Al-based metal source with an atomization gas and an oxygen-containing gas; and
forming, with the oxygen, an oxide within the raw Al-based metal powder such that a majority of the Al-based metallic particles have a particle oxygen concentration that is greater than the initial oxygen concentration of the Al-based metallic source material.
